(19) United States
(12) Patent Application Publication
(10) Pub. No.: US 2013/0265001 A1
(43) Pub. Date: Oct. 10, 2013

(54) BATTERY AND METHOD OF USE

(71) Applicant: XGlow P/T, LLC, Scottsdale, AZ (US)

(72) Inventors: Richard S. Popper, Scottsdale, AZ (US); Jensen Jorgensen, Scottsdale, AZ (US)

(21) Appl. No.: 13/894,547

(22) Filed: May 15, 2013

Related U.S. Application Data
(63) Continuation-in-part of application No. 13/536,721, filed on Jun. 28, 2012, now Pat. No. 8,512,885.
(60) Provisional application No. 61/586,196, filed on Jan. 13, 2012.

(51) Int. Cl. H01M 2/30; H02J 7/00; F21L 4/08; H01M 2/02

(52) U.S. Cl. CPC H01M 2/30; H01M 2/022; H02J 7/00; F21L 4/08
USPC 320/107; 429/179; 429/164; 320/127; 362/202; 362/183

(57) ABSTRACT

A battery includes a battery case including battery chemistry for supplying electricity, a first end, and a second end opposite the first end; a first positive terminal, a first negative terminal, a first conductive communications link, and first insulators electrically isolating the terminals and link at the first end, and together form a first terminal configuration; a second positive terminal, a second negative terminal, a second conductive communications link, and second insulators electrically isolating the terminals and link at the second end, and together form a second terminal configuration, wherein the second terminal configuration is a mirror image of the first terminal configuration.

### CROSS-REFERENCE TO RELATED APPLICATION

This application is a continuation-in-part of nonprovisonal patent application Ser. No. 13/536,721, filed Jun. 28, 2012, and claims the benefit of provisional application 61/586,196, filed on Jan. 13, 2012. Both of these applications are hereby incorporated herein by reference.

### FIELD OF THE INVENTION

The present invention relates to batteries and to battery circuits.

### BACKGROUND OF THE INVENTION

A typical battery has two terminals. One terminal is marked (+), or positive, and the other is marked (−), or negative. In normal flashlight batteries, such as conventional AA, C or D cell batteries, the terminals are located at the opposed ends of the battery. To harness the electric charge produced by a battery, the battery must be connected to a load, such as a light bulb, a motor, or an electrical circuit.

The internal workings of a battery are housed within a metal or plastic case. Inside this case are a cathode, which connects to the positive terminal, and a corresponding anode, which connects to the negative terminal. These components, which are electrodes, occupy most of the space in a battery and are the place where the chemical reactions occur to produce electricity. An insulator or separator creates a barrier between the cathode and anode isolating the cathode from the anode preventing the electrodes from touching while allowing electrical charge to flow freely between them. The medium that allows the electric charge to flow between the cathode and anode is known as the electrolyte. A collector conducts the charge to the outside of the battery and through the applied load.

When a load completes the circuit between the positive and negative terminals, the battery produces electricity through a series of electromagnetic reactions between the anode, the cathode, and the electrolyte. The anode experiences an oxidation in which two or more ions from the electrolyte combine with the anode, producing a compound and releasing one or more electrons. At the same time, the cathode goes through a reduction reaction, in which the cathode substance, ions, and free electrons also combine to form compounds. The reaction in the anode creates electrons, the reaction in the cathode absorbs them, and the net product is electricity. The battery will continue to produce electricity until one or both of the electrodes run out of the substance necessary for the reactions to occur. Modern batteries use a variety of chemicals to power their reactions. Common battery chemistries include zinc-carbon batteries, alkaline batteries, lithium-ion batteries, and lead-acid batteries.

The zinc-carbon chemistry of zinc-carbon batteries is common in many inexpensive AAA, AA, C, and D dry cell batteries, in which the anode is zinc, the cathode is manganese dioxide, and the electrolyte is ammonium chloride or zinc chloride. The chemistry of alkaline batteries is also common in AA, C, and D dry cell batteries. In alkaline batteries, the cathode is composed of a manganese dioxide mixture, the anode is a zinc powder, and the electrolyte is potassium hydroxide, which is an alkaline substance. The lithium chemistry of lithium-ion batteries is often used in high-performance devices, such as cell phones, digital cameras, and electric cars. Lithium-ion batteries are rechargeable, and a variety of substances are used in lithium batteries, and a common combination is a lithium cobalt oxide cathode and a corresponding carbon anode. Lead-acid batteries are also rechargeable, and the corresponding chemistry, which is used in conventional car batteries, includes lead dioxide and metallic lead for the electrodes, and a sulfuric acid solution for the electrolyte. The most common form of rechargeable battery is the lithium-ion battery.

With the rise of portable electronic devices, such as laptops, cell phones, flashlights, cordless power tools, and the like, the need for rechargeable batteries has grown substantially in recent years. Many portable electronic devices that use rechargeable batteries incorporate one contact region for an operating circuit for operating the load, and a second contact point for a charging circuit used to recharge the battery. The operating circuit operates separately from the charging circuit. This is normally achieved by using either a battery cradle that contains the necessary circuits, or an inner barrel inside the body of the electronic device to carry the extra current. Although both methods are effective, they add extra weight and increased cost in the product of the electronic devices and in some instances make it inconvenient and cumbersome to remove or replace a battery as may be necessary from time-to-time. Given these and other deficiencies in the art of batteries, the need for continued improvement in the field is evident.

Also, for certain flashlight models there is a need for more than one printed circuit board (PCB) to be installed. For example, a PCB may be needed on the tail cap of the light and a PCB may be needed on the head of the light that communicate with each other so that they can perform the same functions. When using conventional batteries, it is required to build an extra channel for making electrical contact between the front PCB and the back PCB. This is usually done in the form of a battery sleeve, or is done by building extra contacts into the body of the light, which can add extra cost to the light as well as negatively affect the size and usability of the light.

### SUMMARY OF THE INVENTION

An aspect of the invention involves a battery having a battery case including battery chemistry for supplying electricity, a first end, and a second end opposite the first end; a first positive terminal, a first negative terminal, and a first insulator there between at the first end, and together form a first positive terminal and negative terminal configuration; a second positive terminal, a second negative terminal, and a second insulator there between at the second end, and together form a second positive terminal and negative terminal configuration, wherein the second positive terminal and the second negative terminal configuration is a mirror image of the first positive terminal and the first negative terminal configuration.

One or more implementations of the aspect of the invention described immediately above include one or more of the following: the battery is rechargeable; the battery chemistry lithium-ion chemistry; the battery chemistry is zinc-carbon chemistry; the battery chemistry is lead-acid chemistry; the battery chemistry is alkaline chemistry; the battery is elongated and cylindrical in shape; the first positive terminal and the second positive terminal are circular, located at a geometric center of the first and second ends, and are symmetrical about a longitudinal axis of the battery, the first and second insulators are continuous circular rings, encircle the first and second positive terminals, are located between the first and second positive terminals and the first and second negative terminals, and are symmetrical about the longitudinal axis of the battery, and first and second negative terminals are continuous circular rings that concurrently encircle first and second separators and first and second positive terminal, and are symmetrical about the longitudinal axis of the battery, the first and second positive terminals, the first and second negative terminals, and first and second insulators are concentric and share the longitudinal axis as a common center; a first load connected to the first positive terminal and the first negative terminal at the first end and a second load connected to the second positive terminal and the second negative terminal at the second end; a load connected to the first positive terminal and the first negative terminal at the first end and a charger connected to the second positive terminal and the second negative terminal at the second end; a first charger connected to the first positive terminal and the first negative terminal at the first end and a second charger connected to the second positive terminal and the second negative terminal at the second end; a battery-powered electronic device comprising a body; and a load carried by the body and powered by the battery; a charger coupled to the battery to charge the battery; the battery-powered electronic device is a portable flashlight, the body is a handle of the flashlight, the load is a lamp of the flashlight, and the battery is carried in the handle of the flashlight; a charger coupled to the battery to charge the battery; a battery-powered electronic device including a body and a load carried by the body and powered by the battery, comprising: receiving a first battery in the battery-powered electronic device, the first battery having the construction of the battery and being disposed in a first orientation with the second positive terminal and second negative terminal configuration facing in one direction and the first positive terminal and first negative terminal configuration facing in an opposite direction; replacing the first battery with a second battery in the battery-powered electronic device, the second battery having the construction of the battery and being disposed in a second orientation opposite the first orientation; a method of using a battery-powered electronic device including a body and a load carried by the body and powered by the battery, comprising: receiving a first battery in the battery-powered electronic device, the first battery having the construction of the battery and being disposed in a first orientation with the second positive terminal and second negative terminal configuration facing in one direction and the first positive terminal and first negative terminal configuration facing in an opposite direction; receiving a second battery in the battery-powered electronic device adjacent to the first battery and in direct series connection therewith, the second battery having the construction of the battery and being disposed in a second orientation opposite of the first orientation.

Another aspect of the invention involves a modification of the above rechargeable battery to add an extra contact ring, allowing a normal flashlight design, but still have the extra capabilities for a front PCB and a back PCB to communicate. This not only eliminates the need to for a battery sleeve or adding extra contacts into the body of the light at the expense of increased cost, weight, and size, but also allows for the creation of future accessories for flashlight models, where added functions can be added to an existing flashlight by just modifying the tail cap and battery.

A further aspect of the invention involves a battery including a battery case having battery chemistry for supplying electricity, a first end, and a second end opposite the first end; a first positive terminal, a first negative terminal, a first conductive communications link, and first insulators electrically isolating the terminals and link at the first end that together form a first terminal configuration; a second positive terminal, a second negative terminal, a second conductive communications link, and second insulators electrically isolating the terminals and link at the second end that together form a second terminal configuration, wherein the second terminal configuration is a mirror image of the first terminal configuration.

One or more implementations of the aspect of the invention described immediately above include one or more of the following: the battery is rechargeable; the battery chemistry lithium-ion chemistry; the battery chemistry is zinc-carbon chemistry; the battery chemistry is lead-acid chemistry; the battery chemistry is alkaline chemistry; the battery is elongated and cylindrical in shape; the first positive terminal and the second positive terminal are circular, located at a geometric center of the first and second ends, and are symmetrical about a longitudinal axis of the battery, the first and second negative terminals are continuous circular rings that concurrently encircle first and second positive terminal, and are symmetrical about the longitudinal axis of the battery, the first and second conductive communications links are continuous circular rings that concurrently encircle first and second positive terminal and first and second negative terminal, and are symmetrical about the longitudinal axis of the battery, and the first and second positive terminals, the first and second negative terminals, and first and second conductive communications links are concentric and share the longitudinal axis as a common center; a first load connected to the first positive terminal and the first negative terminal at the first end and a second load connected to the second positive terminal and the second negative terminal at the second end; a load connected to the first positive terminal and the first negative terminal at the first end and a charger connected to the second positive terminal and the second negative terminal at the second end; a first charger connected to the first positive terminal and the first negative terminal at the first end and a second charger connected to the second positive terminal and the second negative terminal at the second end; a first PCB connected to the first conductive communications link at the first end and a second PCB connected to the second conductive communications link at the second end; a battery-powered electronic device, comprising: a body; and a load carried by the body and powered by the battery; a charger coupled to the battery to charge the battery; the battery-powered electronic device is a portable flashlight, the body is a handle of the flashlight, the load is a lamp of the flashlight, and the battery is carried in the handle of the flashlight; a charger coupled to the battery to charge the battery; a first PCB coupled to the first conductive communications link and a second PCB coupled to the second conductive communications link; a method of using a battery-powered electronic device including a body and a load carried by the body and powered by the battery; receiving a first battery in the battery-powered electronic device, the first battery having the construction of the battery above and being disposed in a first orientation with the second terminal configuration facing in one direction and the first terminal configuration facing in an opposite direction; replacing the first battery with a second battery in the battery-powered electronic device, the second battery having the construction of the battery and being disposed in a second orientation opposite the first orientation; first and second PCBs, and the first PCB is coupled to the first conductive communications link and the second PCB is coupled to the second conductive communications link in the first orientation and the first PCB is coupled to the second conductive communications link and the second PCB is coupled to the first conductive communications link in the second orientation; a battery-powered electronic device including a body and a load carried by the body and powered by the battery, comprising: receiving a first battery in the battery-powered electronic device, the first battery having the construction of the battery and being disposed in a first orientation with the second negative terminal configuration facing in one direction and the first terminal configuration facing in an opposite direction; receiving a second battery in the battery-powered electronic device adjacent to the first battery and in direct series connection therewith, the second battery having the construction of the battery and being disposed in a second orientation opposite of the first orientation.

### BRIEF DESCRIPTION OF THE DRAWINGS

FIG. 1 is a perspective of a battery constructed and arranged in accordance with the principle of the invention;

FIG. 2 is another perspective view of the battery of FIG. 1;

FIG. 3 is a schematic diagram of the battery of FIGS. 1 and 2 incorporated into a battery-powered electronic device having a load component and a charging component, and further illustrating a load circuit for powering the load component formed between one end of the battery and the load component, and a charging circuit for charging the battery formed between the opposed end of the battery and the charging component;

FIG. 4 is perspective view of a battery constructed and arranged in accordance with another embodiment of the invention;

FIG. 5 is a front elevational view of the battery of FIG. 4;

FIG. 6 is a top plan view of the battery of FIG. 4;

FIG. 7 is a bottom plan view of the battery of FIG. 4;

FIG. 8 is a schematic diagram of the battery of FIGS. 4-7 incorporated into a battery-powered electronic device having a load component, a charging component, and printed circuit boards (PCBs), and further illustrating a load circuit for powering the load component formed between one end of the battery and the load component, a charging circuit for charging the battery formed between the opposed end of the battery and the charging component, and a PCB circuit for communicating PCBs in different areas of the battery-powered electronic device, which are separated by the battery; and

FIGS. 9-14 are top plan views of further embodiments of the battery.

### DETAILED DESCRIPTION OF THE PREFERRED EMBODIMENTS

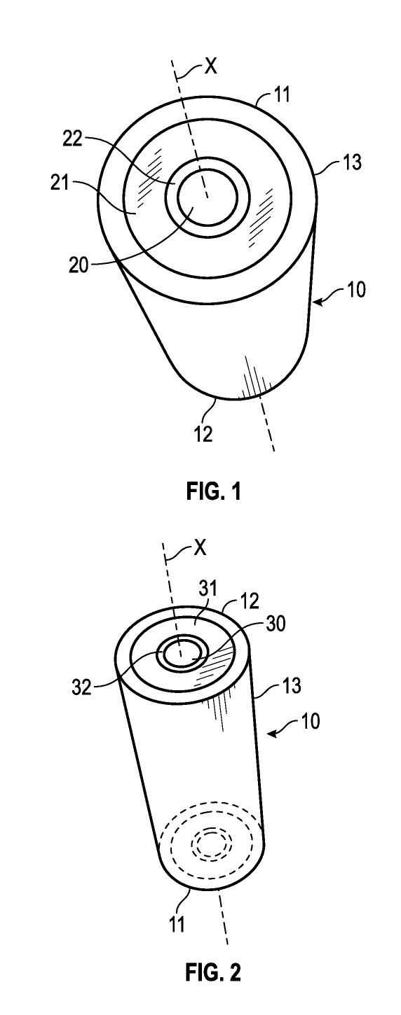

Turning now to the drawings, in which like reference characters indicate corresponding elements throughout the several views, attention is first directed to FIGS. 1 and 2 in which there is seen a battery 10 constructed and arranged in accordance with the principle of the invention. Battery 10 is elongate and cylindrical in shape, has opposed ends 11 and 12, and is symmetrical along its central, longitudinal axis X extending centrally through battery 10 from end 11 to end 12. The internal workings of battery 10 are housed within a metal or plastic case 13, which extends along the length of battery 10 from end 11 to end 12. End 11 of battery 10 as illustrated in FIG. 1 is formed with a positive terminal denoted at 20 and a negative terminal denoted at 21, and end 12 of battery 10 as shown in FIG. 2 is formed with a positive terminal denoted at 30 and a negative terminal denoted at 31. Positive and negative terminals 20 and 21 are located at end 11 of battery 10, and positive and negative terminals 30 and 31 are located at end 12 of battery 10. Positive terminal 20 and negative terminal 21 at end 11 of battery 10 are separated by an insulator or separator 22 at end 11 of battery 10 that electrically isolates positive terminal 20 from negative terminal 21. Positive terminal 30 and negative terminal 31 at end 12 of battery 10 are separated by an insulator or separator 32 at end 11 of battery 10 that electrically isolates positive terminal 30 from negative terminal 31.

As seen in FIG. 1, positive terminal 20 is circular, is located at the geometric center of end 11 of battery 10, and is symmetrical about longitudinal axis X of battery 10. Separator 22 is a continuous circular ring, encircles positive terminal 20, and is, like positive terminal 20, symmetrical about longitudinal axis X of battery 10. Separator 22 is located between positive terminal 20 and negative terminal 21. Negative terminal 21 is located distally of positive terminal 20 and separator 22, is a continuous circular ring that concurrently encircles separator 22 and positive terminal 20, and is, like positive terminal 20 and separator 22, symmetrical about longitudinal axis X of battery 10. Positive terminal 20, negative terminal 21, and separator 22 at end 11 of battery 10 are concentric in arrangement in that they encircle and share a common center, namely, longitudinal axis X of battery 10.

As seen in FIG. 2, positive terminal 30 is circular, is located at the geometric center of end 12 of battery 10, and is symmetrical about longitudinal axis X of battery 10. Separator 32 is a continuous circular ring, encircles positive terminal 30, and is, like positive terminal 30, symmetrical about longitudinal axis X of battery 10. Separator 32 is located between positive terminal 30 and negative terminal 31. Negative terminal 31 is located distally of positive terminal 30 and separator 32, is a continuous circular ring that concurrently encircles separator 32 and positive terminal 30, and is, like positive terminal 30 and separator 32, symmetrical about longitudinal axis X of battery 10. Positive terminal 30, negative terminal 31, and separator 32 at end 12 of battery 10 are concentric in arrangement in that they encircle and share a common center, namely, longitudinal axis X of battery 10.

Positive terminal 30 at end 12 of battery 10 is identical in size and shape to positive terminal 20 at end 11 of battery 10, negative terminal 31 at end 12 of battery 10 is identical in size and shape to positive terminal 21 at end 11 of battery 10, and separator 32 at end 12 of battery 10 is identical in size and shape to separator 22 at end 11 of battery 10. The arrangement and geometry of positive and negative terminals 30 and 31 and separator 32 at end 12 of battery 10 is identical to or otherwise the mirror image of the arrangement and geometry of positive and negative terminals 20 and 21 and separator 22 at end 11 of battery 11.

The internal workings of battery 10 inside case 13 are not shown as they are conventional. As with a conventional battery, inside case 13 are a cathode that connects to opposed positive terminals 20 and 30, and a corresponding anode that connects to opposed negative terminals 21 and 31. These components, which are electrodes, occupy most of the space in battery 10 and are the place where the chemical reactions occur to produce electricity. An insulator or separator creates a barrier between the cathode and anode isolating the cathode from the anode preventing the electrodes from touching while allowing electrical charge to flow freely between them. In a preferred embodiment, separators 22 and 32 form part of the separator separating the cathode from the anode. However, the separator separating the cathode from the anode can be different from separators 22 and 32 in an alternate embodiment. The medium that allows the electric charge to flow between the cathode and anode is the electrolyte, and, as in a conventional battery, a collector conducts the charge to the outside of the battery and through the applied load. Battery 10 is a rechargeable battery, and preferably utilizes lithium chemistry to power its reactions to produce electricity. The lithium chemistry used by battery preferably includes lithium cobalt oxide for the cathode, and carbon for the corresponding anode.

Because both ends 11 and 12 of battery 10 have positive and negative terminals according to the principle of the invention, harnessing the electric charge produced by battery 10 can be produced at end 11 of battery 10 with positive and negative electrodes 20 and 21, and can also be identically produced at end 12 of battery with positive and negative electrodes 30 and 31. Recharging battery 10 can also be made at end 11 of battery 10 with positive and negative electrodes 20 and 21, and can further be identically made at end 12 of battery with positive and negative electrodes 30 and 31.

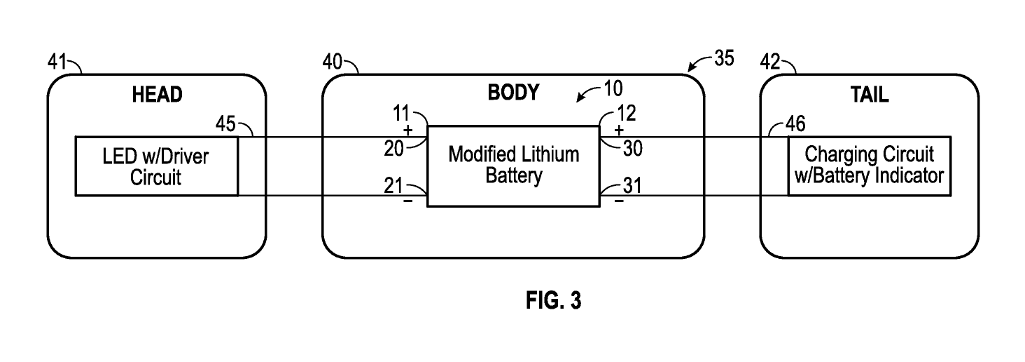

As a matter of example, FIG. 3 is a schematic diagram of battery 10 incorporated into a body 40 of a battery-powered electronic device 35 having a load component 41 and a charging component 42, a load circuit 45 for powering load component 41 formed between end 11 of battery 10 and load component 41, and a charging circuit 46 for charging battery 10 formed between end 12 of battery 10 and charging component 42. In FIG. 3, positive and negative terminals at end 11 of battery 10 are denoted generally at 20 and 21, respectively, and are shown as they would appear connected to load component 41 forming or otherwise completing load circuit 45 between load component 41 and positive and negative terminals 20 and 21 at end 11 of battery 10 causing battery 10 to produce electric power for powering load component 41. Positive and negative terminals at end 12 of battery 10 are denoted generally at 30 and 31, respectively, and are shown as they would appear connected to charging component 42 forming or otherwise completing charging circuit 46 between charging component 42 and positive and negative terminals 30 and 31 at end 11 of battery 10 causing battery 10 to receive charging energy from charging component 42 for charging battery 10. Because the positive and negative terminal geometry and configuration is the same at ends 11 and 12 of battery 10, the orientation of battery 10 in body 40 of battery-powered electronic device 35 can be reversed for forming load circuit 45 between load component 41 and positive and negative terminals 30 and 31 at end 12 of battery 10, and for forming charging circuit 46 between charging component 42 and positive and negative terminals 20 and 21 at end 11 of battery 10, in accordance with the principle of the invention. Regardless of the position of battery 10 in the battery receptacle of body 40, whether end 11 to load component 41 and end 12 to charging component 42 or end 11 to charging component 42 and end 12 to load component, the positive and negative terminal geometry and configuration at ends 11 and 12 of battery 10 are able to produce the corresponding load and charging circuits 45 and 46, in accordance with the principle of the invention. In FIG. 3, battery-powered electronic device 35 is generally representative of a portable flashlight, where body 40 is the body of the flashlight, load component 41 is the lamp of the flashlight, and charging component 42 is the charging cap of the flashlight. Battery 10 can be similarly used in other portable electronic devices having corresponding load and charging components.

By providing battery 10 with identical positive and negative terminals at ends 11 and 12, the need for incorporating dedicated load and charging contacts and circuits, a battery cradle wired with dedicated load and charging circuitry, or an inner barrel to carry the extra current in a battery-powered electronic device is no longer necessary, which reduces the overall weight and cost of a battery-powered electronic device. Furthermore, because the positive and negative terminals at ends 11 and 12 of battery 10 are identical, battery 10 may be installed into a battery cradle or receptacle of a battery-powered electronic device simply and efficiently without the need to find the correct way of inserting the battery as it can be inserted both ways or otherwise in either direction. This is especially useful when a battery needs to be replaced urgently and quickly, such as in the dark. In the present embodiment, terminals 20 and 30 are positive and terminals 21 and 31 are negative, and this can be reversed if so desired.

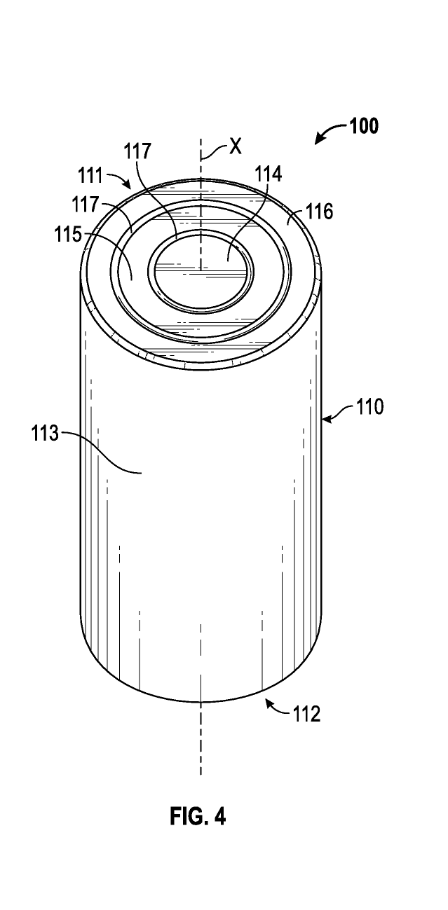

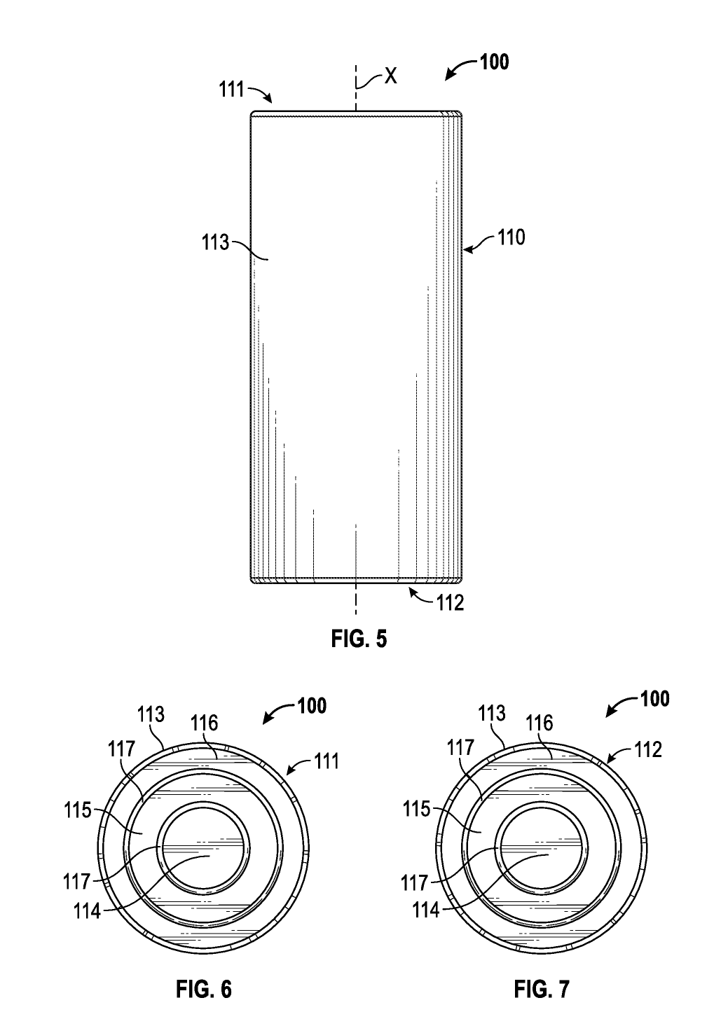

With reference to FIGS. 4-8, another embodiment of a battery 100, which is a modification of battery 10 described above and shown in FIGS. 1-3, will be described. The battery 100 modifies battery 10 by adding an extra contact ring 116 for communicating a front PCB 122 and a back PCB 124. Like elements to those described above with respect to battery 10 and FIGS. 1-3 may use the same reference number or a reference number with the same last two digits. Because battery 100 is a modification of battery 10, the description of battery 10 is incorporated herein, and not repeated.

The battery 100 includes a battery body 110 with a tubular case 113 housing a battery chemistry such as that described above and having flat, opposed ends 111, 112 on each side. On both these flat ends 111, 112 there will be three conductive contact areas 114, 115, 116.

In the center, there will be a first positive pole (cathode) conductive contact area 114 similar to positive terminals 20, 30, a second conductive contact ring area 115 that is a negative pole (anode) and similar to negative terminals 21, 31, and a third conductive contact ring area 116 that is a communications link.

The communications link 116 on both ends 111, 112 of the battery 100 is linked to each other with a wire or other conventional electrical connection running down the side of the battery, hidden under the outer case 113 of the battery body 110. This configuration allows the battery 100 to be charged from (and power supplied from) either end 111, 112 without needing a connection to the other side 111, 112, as described above with respect to FIGS. 1-3 and allows front and rear printed circuit boards (PCBs) 122, 124 of a battery-powered electronic device 35 such as a flashlight to electronically communicate with each other through the communication link 116 and a PCB circuit 120.

Each of these conductive areas 114, 115, 116 are separated by an insulator or separator 117 similar to insulators/separators 22, 32. The insulator 117 is either sunken, at same level, or higher than the conductive contact areas 114, 115, 116. In alternative embodiments, the positions and/or configurations of conductive contact areas 114, 115, 116 and/or insulated material(s) 117 may be swapped and/or different than that shown, provided that the orders of these components and their respective separators are the same at both ends, to achieve the same effect.

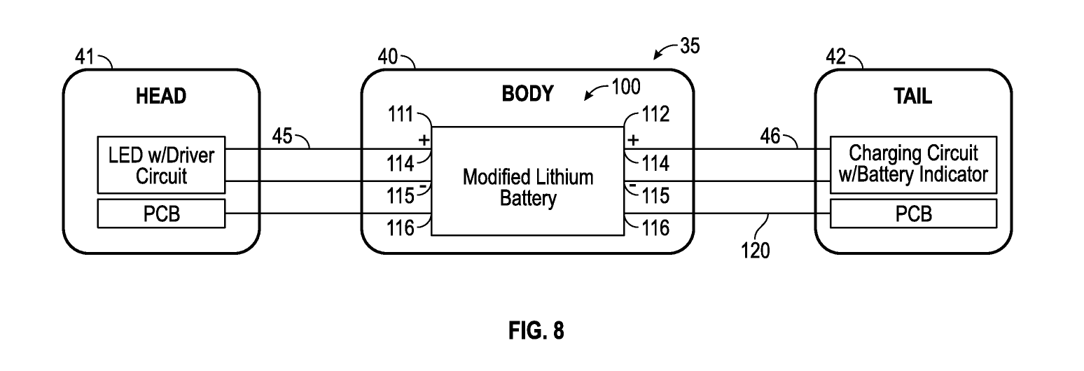

As a matter of example, FIG. 8 is a schematic diagram of battery 100 incorporated into a body 40 of a battery-powered electronic device 35 having a load component 41 and a charging component 42, a load circuit 45 for powering load component 41 formed between end 111 of battery 100 and load component 41, a charging circuit 46 for charging battery 100 formed between end 112 of battery 100 and charging component 42, a first front printed circuit board (PCB) 122, a PCB circuit 120 electrically communicating third communications link conductive contact ring area 116 with the first front printed circuit board (PCB) 122, a second back printed circuit board (PCB) 124, and PCB circuit 120 electrically communicating third communications link conductive contact ring area 116 with the second back printed circuit board (PCB) 124.

Because the geometry and configuration of the contact areas 114, 115, 116 are the same at ends 111 and 112 of battery 100, the orientation of battery 100 in body 40 of battery-powered electronic device 35 can be reversed without affecting the performance of any of the load, charging, and PCB components.

Although the battery-powered electronic device 35 is generally representative of a portable flashlight, where body 40 is the body of the flashlight, load component 41 is the lamp of the flashlight, and charging component 42 is the charging cap of the flashlight, in alternative embodiments, the battery-powered electronic device 35 is an electronic device other than a flashlight and the battery 100 is similarly used in such other portable electronic devices having corresponding load, charging, and PCB components.

The battery 100 enables flashlights to have a normal flashlight design, but still have the extra capabilities for front PCB 122 and back PCB 124 to communicate. This not only eliminates the need to for a battery sleeve or adding extra contacts into the body of the light at the expense of increased cost, weight, and size, but also allows for the creation of future accessories for flashlight models, where added functions can be added to an existing flashlight by just modifying the tail cap and battery.

As shown in FIGS. 9-14, in further embodiments, the battery 100 includes other numbers of conductive contact areas (e.g., 4, 5, 6, 7, 8, 9, etc.) and corresponding insulators/separators on opposed ends.

While illustrative embodiments of the invention are disclosed herein, it will be appreciated that numerous modifications and other embodiments can be devised by those skilled in the art. Features of the embodiments described herein, can be combined, separated, interchanged, and/or rearranged to generate other embodiments. Therefore, it will be understood that the appended claims are intended to cover all such modifications and embodiments that come within the spirit and scope of the present invention.

What is claimed:

1. A battery, comprising:
a battery case including battery chemistry for supplying electricity, a first end, and a second end opposite the first end;
a first positive terminal, a first negative terminal, a first conductive communications link, and first insulators electrically isolating the terminals and link at the first end, and together form a first terminal configuration;
a second positive terminal, a second negative terminal, a second conductive communications link, and second insulators electrically isolating the terminals and link at the second end, and together form a second terminal configuration,
wherein the second terminal configuration is a mirror image of the first terminal configuration.

2. The battery of claim 1, wherein the battery is rechargeable.

3. The battery of claim 1, wherein the battery chemistry lithium-ion chemistry.

4. The battery of claim 1, wherein the battery chemistry is zinc-carbon chemistry.

5. The battery of claim 1, wherein the battery chemistry is lead-acid chemistry.

6. The battery of claim 1, wherein the battery chemistry is alkaline chemistry.

7. The battery of claim 1, wherein the battery is elongated and cylindrical in shape.

8. The battery of claim 1, wherein the first positive terminal and the second positive terminal are circular, located at a geometric center of the first and second ends, and are symmetrical about a longitudinal axis of the battery, the first and second negative terminals are continuous circular rings that concurrently encircle first and second positive terminal, and are symmetrical about the longitudinal axis of the battery, the first and second conductive communications links are continuous circular rings that concurrently encircle first and second positive terminal and first and second negative terminal, and are symmetrical about the longitudinal axis of the battery, and the first and second positive terminals, the first and second negative terminals, and first and second conductive communications links are concentric and share the longitudinal axis as a common center.

9. The battery of claim 1, further including a first load connected to the first positive terminal and the first negative terminal at the first end and a second load connected to the second positive terminal and the second negative terminal at the second end.

10. The battery of claim 1, further including a load connected to the first positive terminal and the first negative terminal at the first end and a charger connected to the second positive terminal and the second negative terminal at the second end.

11. The battery of claim 1, further including a first charger connected to the first positive terminal and the first negative terminal at the first end and a second charger connected to the second positive terminal and the second negative terminal at the second end.

12. The battery of claim 1, further including a first PCB connected to the first conductive communications link at the first end and a second PCB connected to the second conductive communications link at the second end.

13. A battery-powered electronic device, comprising:
a body; and
a load carried by the body and powered by the battery of claim 1.

14. The battery-powered electronic device of claim 13, further including a charger coupled to the battery to charge the battery.

15. The battery-powered electronic device of claim 13, wherein the battery-powered electronic device is a portable flashlight, the body is a handle of the flashlight, the load is a lamp of the flashlight, and the battery is carried in the handle of the flashlight.

16. The battery-powered electronic device of claim 15, further including a charger coupled to the battery to charge the battery.

17. The battery-powered electronic device of claim 13, further including a first PCB coupled to the first conductive communications link and a second PCB coupled to the second conductive communications link.

18. A method of using a battery-powered electronic device including a body and a load carried by the body and powered by the battery of claim 1, comprising:
receiving a first battery in the battery-powered electronic device, the first battery having the construction of the battery of claim 1 and being disposed in a first orientation with the second terminal configuration facing in one direction and the first terminal configuration facing in an opposite direction;
replacing the first battery with a second battery in the battery-powered electronic device, the second battery having the construction of the battery of claim 1 and being disposed in a second orientation opposite the first orientation.

19. The method of claim 18, wherein the battery-powered electronic device includes first and second PCBs, and the first PCB is coupled to the first conductive communications link and the second PCB is coupled to the second conductive communications link in the first orientation and the first PCB is coupled to the second conductive communications link and the second PCB is coupled to the first conductive communications link in the second orientation.

20. A method of using a battery-powered electronic device including a body and a load carried by the body and powered by the battery of claim 1, comprising:
receiving a first battery in the battery-powered electronic device, the first battery having the construction of the battery of claim 1 and being disposed in a first orientation with the second negative terminal configuration facing in one direction and the first terminal configuration facing in an opposite direction;
receiving a second battery in the battery-powered electronic device adjacent to the first battery and in direct series connection therewith, the second battery having the construction of the battery of claim 1 and being disposed in a second orientation opposite of the first orientation.
